(19) United States
(12) Patent Application Publication
(10) Pub. No.: US 2015/0014538 A1
(43) Pub. Date: Jan. 15, 2015

(54) Detector Electronics

(71) Applicant: CorDEX Instruments Limited, Cleveland (GB)

(72) Inventor: Antony James Holliday, Cleveland (GB)

(21) Appl. No.: 14/312,861

(22) Filed: Jun. 24, 2014

(30) Foreign Application Priority Data
Jun. 24, 2013 (GB) GB 1311150.5

(51) Int. Cl. G01J 5/10; G01J 5/00

(52) U.S. Cl. CPC G01J 5/10; G01J 5/0096; G01J 2005/0077
USPC 250/340; 250/349; 250/338.1

(57) ABSTRACT

An apparatus including a detector comprising a microbolometer, and a power converter operably connected to the detector and a power source. Also a method of operating a detector in a hazardous environment, the method including the steps of providing a detector comprising a microbolometer, a power source, and a power converter operably connected to the detector and the power source; supplying power from the power source to an input of the power converter; converting the power using the power converter to produce an output power; and supplying the output power to the detector.

The present invention relates to a detector suitable for use in a thermal imager. A thermal imager is also known as a thermal imaging, thermographic or infrared camera.

A thermal imager detects infrared radiation emitted from an object or scene within its field of view. It converts the infrared radiation emitted into electrical signals that are displayed on a screen. Thermal imagers convert infrared radiation into visible light. Thermal imagers typically operate at wavelengths from 7,500 to 14,000 nm or from 7.5 to 14 μm. Two objects or areas of a scene at the same temperature are displayed on the screen using the same colour.

Thermal imagers are commonly used to inspect electrical equipment. The thermal imager is used to measure infrared radiation or heat produced by the electrical equipment and converts the measurements into a visible image. Regular inspections of the electrical equipment allow an operator to compare successive readings and thereby detect when the thermal images produced vary over time. An increased thermal reading indicates the particular area of the electrical equipment is heating up and is therefore prone to failure. A thermal imager can therefore be used to provide an early warning system for component failure and help organise a service regime that concentrates on components that are failing and need replacement.

Some thermal imagers are required to be used in hazardous and/or explosive atmospheres. Special consideration must be given to the arrangement of the component parts of such thermal imagers so that they are intrinsically safe.

According to a first aspect of the present invention there is provided an apparatus comprising:
a detector comprising a microbolometer, and
a power converter operably connected to the detector and a power source.

The power source may be a source of electrical energy. The detector, the power source and the power converter may be operably connected by an electrical circuit.

The power converter may have an output voltage and an input voltage. The output voltage may be greater than the input voltage. The output voltage may operably be supplied to the detector. The input voltage may operably be supplied by the power source. In use, the output voltage of the power converter may be at equal to or more than 5 volts, typically from 5 to 5.5 volts. In use, the input voltage may be equal to or less than 4.5 volts.

The power converter may be referred to as a boost converter or step-up converter. The power converter may boost the voltage in at least a part of the electrical circuit. The power converter may be a DC-to-DC power converter. The power converter may comprise at least two switches. Each switch of the at least two switches may be a diode. The power converter may comprise at least one power store. The power store may be one or more of a capacitor and an inductor. The capacitor may store the electrical energy in the form of an electric field.

The microbolometer may comprise a plurality of thermal sensors. The thermal sensors may be referred to as heat sensors. The plurality of heat sensors may each comprise a first layer of vanadium oxide or amorphous silicon. The plurality of heat sensors may each comprise a corresponding second layer of silicon. In use, infrared radiation strikes the vanadium oxide and changes its electrical resistance and this change is measured and used to generate an electronic visual display.

The plurality of heat sensors may comprise at least 20,000 heat sensors, normally at least 70,000 heat sensors and typically at least 76,800 heat sensors. The plurality of heat sensors may be arranged in a grid. The grid of heat sensors may comprise at least a 320×240 array of heat sensors. The grid may be rectangular in shape. The grid of heat of sensors may be a Focal Plane Array (FPA) detector and/or a longwave Focal Plane Array (FPA). The more heat sensors there are the more electrical energy the detector requires and the greater the voltage of electrical energy required.

The detector may be used to convert infrared radiation emitted by an object into visible light. The detector may be part of a thermal imager. The thermal imager may also include a lens. The detector is typically adapted to measure the temperature of an object in front of the lens. The lens may focus infrared radiation emitted by an object in front of the lens onto a surface of the detector. Focusing the infrared energy may include directing the infrared energy onto the surface of the detector.

The detector comprising a plurality of heat sensors typically requires a power source of equal to or greater than 5 volts. The detector comprising a plurality of heat sensors may require a power source of from 5 to 5.5 volts. The detector comprising a plurality of heat sensors typically requires a power source with a power rating of about 100 milliwatts. The detector comprising a plurality of heat sensors typically requires a power source with an electrical current of about 250 mA.

The power source may be provided by one or more cells, typically three cells. Each cell may have a nominal voltage of 1.5 volts. The power source may be 4.5 volts, that may be three times 1.5 volts. Each cell may be an AA-sized battery.

A voltage of 4.5 volts may provide a capacitance of less than or equal to 50 μF (microfarad).

A voltage of less than 5 volts typically renders the voltage nonincendiary, that is not incendiary and therefore not capable of causing a fire. The power source is typically 4.5 volts. The electronic visual display is typically operable with an electrical energy of 4.5 volts and normally 4.8 volts. The voltage of the power source and/or voltage of the electronic visual display are therefore typically less than 5 volts and therefore nonincendiary.

The detector comprising a plurality of heat sensors may require a power source of equal to or greater than 5 volts. The detector may be housed in a casing. The casing may be spark-proof, that is the casing comprises a material that is not damaged by sparks. The casing may protect the detector from the surrounding environment and therefore the detector is intrinsically safe, and may be safely operated in a hazardous and/or explosive atmosphere or area.

The output voltage of the power converter may be equal to or more than 5 volts, typically from 5 to 5.5 volts. The power converter may operate at a voltage of from 5.5 to 6.2 volts. The power converter and/or the protector may be separated from the surrounding environment, typically including other portions of the electrical circuit and/or other electrical circuits. The power converter and/or the protector may be separated from the surrounding environment by infallible tracking. The infallible tracking may be a physical barrier made of non-electrically conductive or insulative material. The barrier may have a thickness or cross-sectional diameter of equal to or greater than 2 mm. The infallible tracking may mitigate the risk of any fault in a separated portion of the electrical circuit affecting another portion of the electrical circuit. The separated portion of the electrical circuit typically includes at least the power converter.

A protector may be operably connected to the electrical circuit. The protector may limit the voltage in the electrical circuit to less than or equal to 6.2 volts. Limiting or controlling the voltage in the electrical circuit and/or the output voltage of the power converter may reduce the chance of an overvoltage occurring. An overvoltage is typically when the voltage in the electrical circuit and/or the output voltage is greater than 6.2 volts.

The protector may comprise at least one Zener diode. The at least one Zener diode may allow the flow of electrical energy in a first direction and/or may restrict the flow of electrical energy in a second direction. The second direction is typically opposed to the first direction. Flow of the electrical energy in the second direction may only be possible when the voltage of the electrical energy is greater than 6.2 volts. The at least one Zener diode may be clamped at 6.2 volts. The at least one Zener diode may have a power rating of 5 watts.

The protector typically comprises at least two Zener diodes. The at least two Zener diodes may be operably connected to the electrical circuit. The at least two Zener diodes may be in parallel in the electrical circuit.

In use, the detector typically generates an electrical signal. The detector is typically in electrical communication with the electronic visual display. The electrical signal is normally transmittable between the detector and the electronic visual display. The electrical communication between the detector and electronic visual display may comprise at least one conductive pathway. In an alternative embodiment the electrical communication may comprise at least one wire.

Typically the electrical communication between the detector and electronic visual display and between other components of the apparatus, including the power source and power converter and the detector are intrinsically safe, that is they may be safely operated in a hazardous and/or explosive atmosphere or area. The electrical communications, power source, power converter, detector and electronic visual display may satisfy the ATEX Directive. The electrical communications, power source, power converter, detector and electronic visual display may satisfy the requirements of BS EN 60079-10. There may be at least one diode connected inline to the at least one electrical communication between the detector and electronic visual display. The at least one diode may be a Schottky diode. Typically in use, there is a low voltage drop across the at least one diode. Typically the at least one diode has a fast switching action, normally a very fast switching action.

The fast or very fast switching action of the at least one diode is an advantage of the present invention because the electronic control and/or communication between the detector and electronic visual display can therefore be fast or very fast. The faster the electronic control and/or communication between the detector and electronic visual display, the more responsive and therefore the more quickly the electronic visual display reacts to changes measured by the detector.

The low voltage drop across the at least one diode is normally from 0.15 to 0.45 volts and may provide the fast or very fast switching time.

The Schottky diode typically comprises a metal and a semiconductor and a junction therebetween. The metal may comprise molybdenum, platinum, chromium and/or tungsten. The semiconductor may be an N-type semiconductor. The metal typically provides an anode and the semiconductor provides a cathode.

In use, the at least one diode may protect the electronic visual display. There may be one diode per electrical communication or conductive pathway. There are typically at least two diodes per electrical communication or conductive pathway. The at least two diodes are typically connected in series and inline to each electrical communication or conductive pathway or wire. Connecting the at least two diodes in series provides two barriers to the transfer of electrical energy or power between the detector and electronic visual display with a voltage of greater than or equal to 5 volts. When in series, if one of the at least two diodes fails, the other diode may provide the barrier to the transfer of electrical energy or power between the detector and electronic visual display with a voltage of greater than or equal to 5 volts.

It is an advantage of the present invention that if one of the at least two diodes fails, the other diode of the at least two diodes provides the necessary fail-safe and limits the electrical energy that can pass from the detector to the electronic visual display and/or surrounding environment.

The Schottky diode is typically a reverse biased Schottky diode. The Schottky diode may be referred to as a Schottky barrier and/or a blocking diode and/or hot carrier diode.

The at least one diode may have a rating with one or more of an average forward current of 3 Amps, a forward voltage of 360 mVolts, a maximum repetitive reverse voltage of 10 volts, and a maximum forward voltage drop of 0.39 volts.

The at least one diode may be a Zener diode.

The power source and electronic visual display may operate at a voltage of 4.5 volts and capacitance of less than or equal to 50 μF and so are nonincendiary, that is not incendiary and therefore not capable of causing a fire. In contrast the detector, when comprising at least a 320×240 array of heat sensors, requires a voltage of equal to or greater than 5 volts and a power rating of about 100 milliwatts to function properly.

There may be at least one resister, typically at least two resisters inline to the at least one electrical communication between the detector and electronic visual display. The at least one resister may be a current limiting resister and may be used to limit the electrical energy or power transfer between the detector and electronic visual display. The resister may dissipate the electrical energy as heat.

The apparatus may be a thermal imager. The apparatus may comprise one or more of a lens, a shutter disposed between the detector and the lens, and a motor operably connected to the shutter for moving the shutter between a first and a second position.

The thermal imager is typically intrinsically safe, that is the thermal imager may be safe for operation in a hazardous and/or explosive atmosphere or area. Intrinsic safety may require the electrical energy supplied to one or more of the detector, lens and motor to be controlled and/or limited. The detector, power source, power converter, lens and motor may be operably connected by the electrical circuit.

The thermal imager may include a processor for processing data collected by the detector. The processor may process the data such that the data is suitable for displaying on the electronic visual display or screen.

According to a second aspect of the present invention there is provided a method of operating a detector in a hazardous environment, the method including the steps of:
providing a detector comprising a microbolometer, a power source, and a power converter operably connected to the detector and the power source,
supplying power from the power source to an input of the power converter,
converting the power using the power converter to produce an output power, and
supplying the output power to the detector.

The method may include the step of connecting the detector, the power source and the power converter in an electrical circuit. The power and output power may be electrical energy.

The power converter may boost or increase the voltage of the power supplied to the power converter. The output power may have a voltage equal to or more than 5 volts, typically from 5 to 5.5 volts. The power supplied from the power source to the input of the power converter may have a voltage of equal to or less than 4.5 volts.

The microbolometer may comprise a plurality of heat sensors. The plurality of heat sensors may each comprise a first layer of vanadium oxide or amorphous silicon. The plurality of heat sensors may each comprise a corresponding second layer of silicon. Infrared radiation striking the vanadium oxide typically changes the electrical resistance of the vanadium oxide. The method may include the step of measuring the change in electrical resistance and producing a corresponding electrical signal. The method may include the step of transmitting the electrical signal between the detector and the electronic visual display. The method may include the step of generating an electronic visual display from the electrical signal.

The method may include the step of providing a protector, operably connected to the electrical circuit. The method may include the step of using the protector to limit the voltage in the electrical circuit to less than or equal to 6.2 volts. Limiting or controlling the voltage in the electrical circuit and/or the output voltage of the power converter may reduce the chance of an overvoltage occurring.

The method may include the step of providing at least one diode between the detector and the electronic visual display to protect the electronic visual display. Typically there are at least two diodes between the detector and the electronic visual display. The at least one diode may have a fast switching action, normally a very fast switching action.

The at least two diodes may be connected in series to provide two barriers to the transfer of electrical energy between the detector and electronic visual display with a voltage of greater than or equal to 5 volts. When in series, if one of the at least two diodes fails, the other diode may provide the barrier to the transfer of electrical energy between the detector and electronic visual display with a voltage of greater than or equal to 5 volts.

The method may provide a safe way of operating a detector in a hazardous environment. The method may be intrinsically safe. The hazardous environment may be an explosive environment.

Optional features of the first aspect of the present invention may be incorporated into the second aspect of the present invention and vice versa.

An embodiment of the invention will now be described by way of example only and with reference to the accompanying drawings, in which:

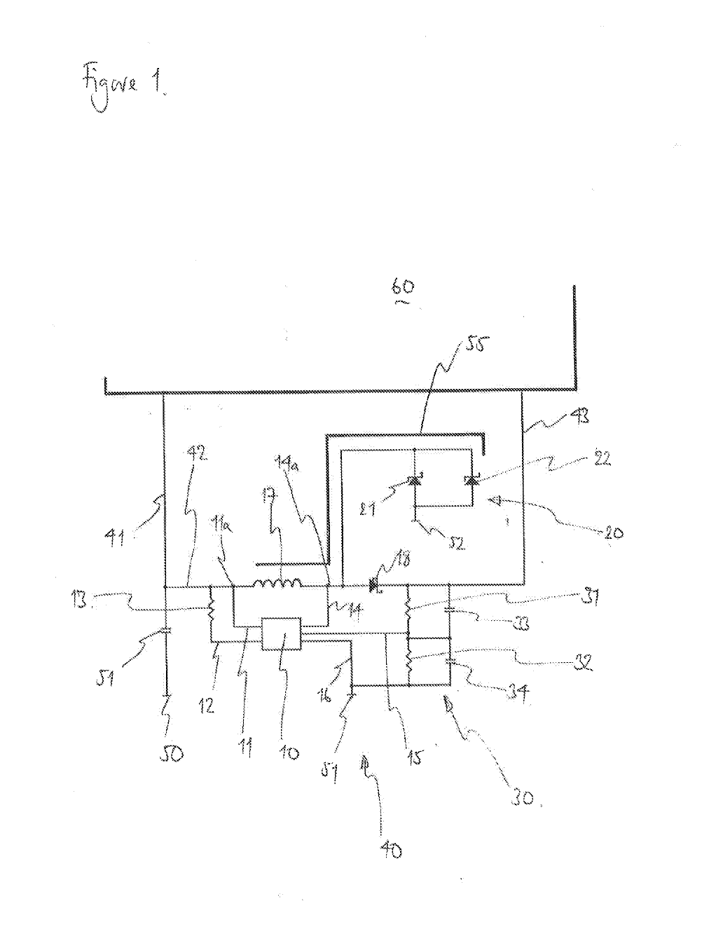

FIG. 1 is a schematic of the power converter and its associated components;

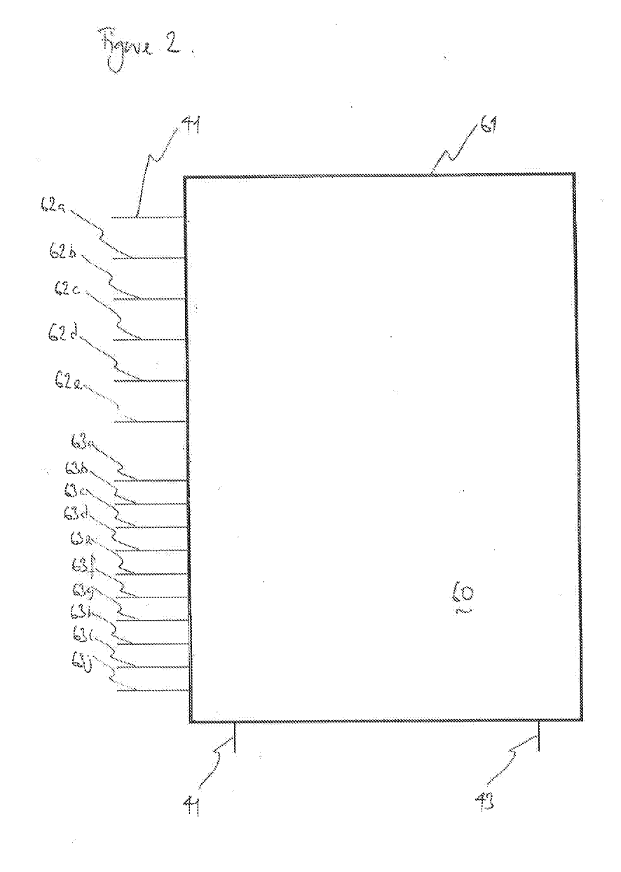

FIG. 2 is a schematic of the detector;

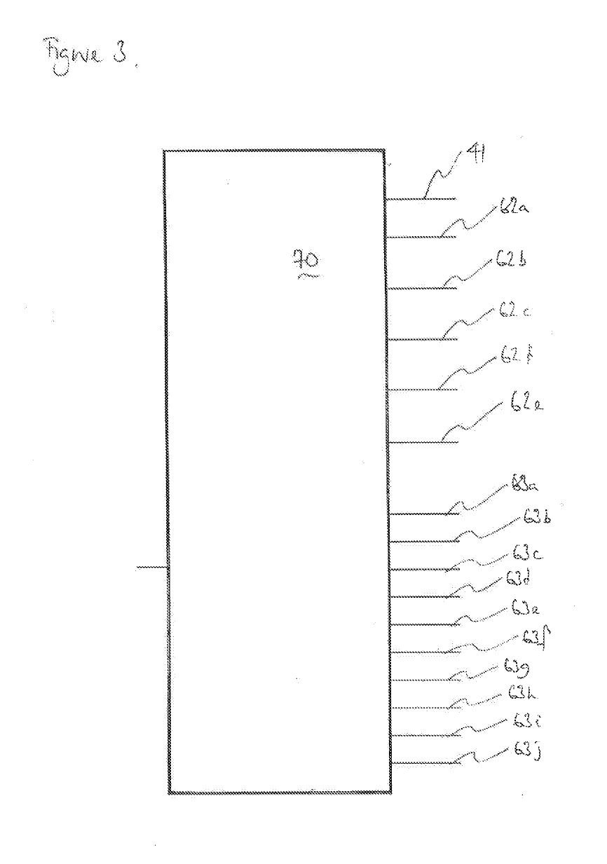

FIG. 3 is a schematic of the electronic visual display; and

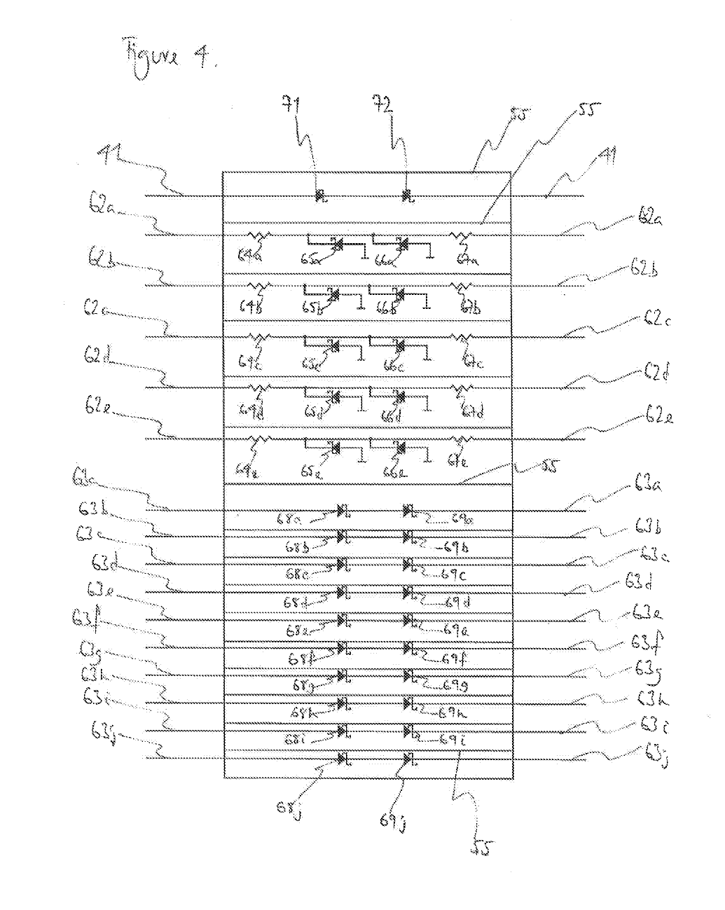

FIG. 4 is a schematic of the electrical communication between the detector and the electronic visual display.

FIGS. 1 to 4 show the various components of the apparatus according to the present invention. The apparatus is part of a thermal imager (not shown). The thermal imager is intrinsically safe, that is it is safe for operation in a hazardous and/or explosive atmosphere.

FIG. 1 shows the power converter 10, protector 20 and feedback loop 30 connected together in an electrical circuit 40. The electrical circuit 40 is connected to the detector 60. The lines between the power converter 10 and various other components of the electrical circuit 40 are conductive pathways on a printed circuit board or wires if the connections are between larger components.

A power source 41 provides the electrical circuit 40 with an input voltage 42 of electrical energy with an electrical potential of 4.5 volts. An output voltage 43 of the electrical circuit 40 has an electrical potential of 5.5 volts. The output voltage 43 of 5.5 volts is greater than the input voltage 42 of 4.5 volts. The output voltage 43 is supplied to the detector 60.

The power converter 10 is a low-power DC/DC boost converter and can be referred to as a TPS61041 type converter. The power converter 10 has an input voltage range of from 1.8 to 6 volts; an adjustable output voltage of up to 28 volts; an internal switch current of 250 mA; and a switching frequency of up to 1 MHz. The power convertor 10 boosts the input voltage 42 of 4.5 volts to an output voltage 43 of 5.5 volts.

The power converter 10 is connected to the input voltage 42 by conductive pathways 11 and 12. The conductive pathway 12 has an inline 1K ohm resister 13. The power source is connected to ground (or earth) 50 via a 1 μF capacitor 51. The power converter 10 is connected to the output voltage 43 by conductive pathway 14. The power converter 10 is also connected to the feedback loop 30 by conductive pathways 15 and 16. Conductive pathway 16 is also connected to ground (or earth) 51.

Between the terminal 11a of the conductive pathway 11 with the input voltage 42 and the terminal 14a of the conductive pathway 14 with the output voltage 43, there is an inductor 17 with air wound coils. The inductor 17 is an SMT (Surface Mount) power inductor with an inductance of 2.2 μH±20% and can be referred to as a LPS3015 low profile shielded power inductor.

The feedback loop 30 has two fixed resistors, the first 31 is a 430K ohm resistor and the second 32 is a 162K ohm resistor. The feedback loop 30 also has two 10 pF capacitors 33 and 34.

Between the terminal 14a and the output voltage 43 there is also a Schottky rectifier 18 and the protector 20. The Schottky rectifier 18 has a low forward voltage of 0.5 A and a power rating of less than 430 mV and can be referred to as a MBR0530 Schottky rectifier.

The protector 20 has two Zener diodes 21 and 22 with a voltage of 6.2 volts; a power dissipation of 5 watts; an operating temperature range of from −65 to +200° C.; and current of 200 mA. The Zener diodes 21 and 22 may be referred to as 1N5341BG type semiconductors. The protector 20 is also connected to ground (or earth) 52. The two Zener diodes 21 and 22 are in parallel in the electrical circuit. The two Zener diodes 21 and 22 of the protector 20 limit the voltage in the electrical circuit 40 to less than or equal to 6.2 volts. Limiting or controlling the voltage in the electrical circuit and/or the output voltage of the power converter reduces the chance of an overvoltage occurring.

The power converter 10, protector 20 and feedback loop 30 are protected from the surrounding environment by infallible tracking 55. The infallible tacking 55 is 2 mm thick and is a physical barrier of insulative material.

FIG. 2 shows the detector 60. FIG. 2 also shows the power source 41 and output voltage 43 referred to in FIG. 1 connected to the detector 60. The detector 60 is a microbolometer (details of the microbolometer are not shown).

The microbolometer comprises 76,800 heat sensors (not shown). Each heat sensor has a first layer of vanadium oxide and a corresponding second layer of silicon. The heat sensors are arranged in a 320×240 array. The grid is rectangular in shape.

The detector 60 operates at a voltage of 6.51 volts; a capacitance of 10.97 μF; and an inductance of 2.77 μH.

In use, infrared radiation strikes the vanadium oxide and changes its electrical resistance. This change is measured and used to generate an image on the electronic visual display 70 (FIG. 3). The detector 60 is used to convert infrared radiation emitted by an object (not shown) into visible light. The detector 60 is part of the thermal imager referred to above.

The detector 60 requires 5.5 volts of electrical power to operate. The output voltage 43 from the power converter 10 referred to in FIG. 1 is 5.5 volts and provides the detector with the electrical power it requires.

A voltage of less than 5 volts renders the voltage nonincendiary, that is not incendiary and therefore not capable of causing a fire. The detector 60 uses a power source of 5.5 volts and so is housed in a casing 61. The casing 61 is spark-proof, that is the casing is not damaged by sparks. The casing protects the detector from the surrounding environment and therefore the detector is intrinsically safe, and may be safely operated in a hazardous and/or explosive atmosphere or area.

In use, the detector 60 generates electrical signals. The detector 60 is in electrical communication with the electronic visual display 70 (shown in FIG. 3). The electrical communication includes the communication of power via the conductive pathways 62a to 62e and the communication of control signals via conductive pathways 63a to 63j. The electrical signals generated by the detector 60 are communicated to the electronic visual display 70 (shown in FIG. 3) using the conductive pathways 62a to 62e and 63a to 63j.

FIG. 3 shows the electronic visual display 70 and the conductive pathways 62a to 62e and 63a to 63j providing the power and control signals to and from the detector 60. The electronic visual display 70 is a Liquid Crystal Display (LCD) with backlight.

The electronic visual display 70 operates at a voltage of 4.794 volts; a capacitance of 1.6 μF; and an inductance of 1.8 μH. The electronic visual display 70 includes a single buck regulator.

FIG. 4 shows details of the connection between the detector 60 (shown in FIG. 2) and the electronic visual display 70 (shown in FIG. 3). The power and control signals transmitted between the detector 60 and electronic visual display 70 pass along the conductive pathways 62a to 62e and 63a to 63j.

The conductive pathways 62a to 62e include two diodes 65a to 65e and 66a to 66e per conductive pathway. The two diodes 65a to 65e and 66a to 66e are connected in series. Connecting the two diodes in series provides two barriers to the transfer of electrical energy or power between the detector 60 and electronic visual display 70 with a voltage of greater than or equal to 5 volts. When in series, if one of the two diodes fails, the other diode provides the necessary fail-safe and limits the electrical energy that can pass from the detector 60 to the electronic visual display 70 and/or surrounding environment.

The diodes 65a to 65e and 66a to 66e are Zener diodes with a Zener voltage of 4.7 volts, a power dissipation of 200 mW; a maximum reverse leakage current of 3 μA; and maximum Zener impedance of 80 ohms. The diodes 65a to 65e and 66a to 66e are small signal, silicon, planar power, Zener diodes and can be referred to as BZX384-B4V7 type diodes. Each of the diodes 65a to 65e and 66a to 66e is connected to ground (earth).

The conductive pathways 62a to 62e also include two resistors 64a to 64e and 67a to 67e per conductive pathway. The two resistors 64a to 64e and 67a to 67e are connected in series. The resistors 64a to 64e are 150 R, 250 mW resistors. The resistors 67a to 67e are 270 R, 250 mW resistors.

The conductive pathways 63a to 63j include two diodes 68a to 68j and 69a to 69j per conductive pathway. The diodes 68a to 68j and 69a to 69j are connected in series. The diodes 68a to 68j and 69a to 69j are Schottky barrier rectifiers with a forward current of 3 A; a reverse voltage of 10 volts; a very low forward voltage; and can be referred to as PMEG1030EJ type diodes.

The diodes 68a to 68j and 69a to 69j have a very fast switching action. The very fast switching action allows the electronic control and/or communication between the detector 60 and electronic visual display 70 to be very fast. The faster the electronic control and/or communication between the detector 60 and electronic visual display 70, the more responsive and therefore the more quickly the electronic visual display 70 reacts to changes measured by the detector 60.

The power source conductive pathway 41 includes two diodes 71 and 72. The two diodes 71 and 72 are connected in series. The two diodes 71 and 72 are Schottky barrier rectifiers with an average forward current of less than or equal to 2 A; a reverse voltage of 60 volts; a low forward voltage; and can be referred to as a PMEG6020EP type diodes.

Each of the conductive pathways 62a to 62e and 63a to 63j, including the corresponding diodes 65a to 65e, 66a to 66e, 68a to 68j, 69a to 69j and resistors 64a to 64e and 67a to 67e, are housed in infallible tracking 55.

Modifications and improvements to the apparatus and method described herein may be made without departing from the scope of the invention.

1. An apparatus comprising:
a detector comprising a microbolometer, and
a power converter operably connected to the detector and a power source.

2. An apparatus according to claim 1, wherein the detector, the power source and the power converter are operably connected in an electrical circuit.

3. An apparatus according to claim 1, wherein in use the power converter has an output voltage and an input voltage, the output voltage being greater than the input voltage, the output voltage being supplied to the detector, the input voltage being supplied by the power source.

4. An apparatus according to claim 3, wherein in use the output voltage of the power converter is from 5 to 5.5 volts and the input voltage is equal to or less than 4.5 volts.

5. An apparatus according to claim 1, wherein the microbolometer comprises at least 70,000 heat sensors.

6. An apparatus according to claim 1, wherein the microbolometer comprises a 320×240 array of heat sensors.

7. An apparatus according to claim 2, wherein the electrical circuit further comprises a protector that in use limits the voltage in the electrical circuit to less than or equal to 6.2 volts.

8. An apparatus according to claim 2, wherein the electrical circuit further comprises a protector that in use limits the voltage in the electrical circuit to less than or equal to 6.2 volts and wherein the power converter and the protector are separated from the surrounding environment by infallible tracking comprising a physical barrier made of insulative material.

9. An apparatus according to claim 2, wherein the electrical circuit further comprises a protector that in use limits the voltage in the electrical circuit to less than or equal to 6.2 volts and wherein the protector comprises at least two Zener diodes operably connected to and in parallel in the electrical circuit.

10. An apparatus according to claim 1, wherein the detector is in electrical communication with an electronic visual display, the electrical communication comprising at least one conductive pathway therebetween with at least two diodes connected in series and inline.

11. An apparatus according to claim 10, wherein the at least two diodes are Schottky diodes with a voltage drop across each diode of from 0.15 to 0.45 volts.

12. A method of operating a detector in a hazardous environment, the method including the steps of:
providing a detector comprising a microbolometer, a power source, and a power converter operably connected to the detector and the power source,
supplying power from the power source to an input of the power converter,
converting the power using the power converter to produce an output power, and
supplying the output power to the detector.

13. A method of operating a detector according to claim 12, the method further including the step of connecting the detector, the power source and the power converter in an electrical circuit.

14. A method of operating a detector according to claim 13, wherein a protector is operably connected to the electrical circuit and the method further including the step of using the protector to limit the voltage in the electrical circuit to less than or equal to 6.2 volts.

15. A method of operating a detector according to claim 12, the method including the step of providing at least two diodes between the detector and an electronic visual display to protect the electronic visual display, the at least two diodes being connected in series to provide two barriers to the transfer of electrical energy between the detector and the electronic visual display with a voltage of greater than or equal to 5 volts.
